(19) United States
(12) Patent Application Publication
(10) Pub. No.: US 2011/0139132 A1
(43) Pub. Date: Jun. 16, 2011

(54) EXHAUST GAS RECIRCULATION VALVE THRUST COLLAR

(76) Inventors: Kristopher Smith, Thamesville (CA); Jack Gurd, Wallaceburg (CA); Robert D. Jefford, Chatham (CA); Benjamin Williams, Chatham (CA)

(21) Appl. No.: 12/997,350

(22) PCT Filed: Jun. 12, 2009
(86) PCT No.: PCT/CA09/00825

§ 371 Date: Dec. 10, 2010

Related U.S. Application Data
(60) Provisional application No. 61/060,913, filed on Jun. 12, 2008.

(51) Int. Cl. F02M 25/07

(52) U.S. Cl. 123/568.11

(57) ABSTRACT

An EGR valve includes a flap is attached to a shaft and is rotatable to control exhaust gas flow through passage. The flap includes sealing ring for sealing against valve seat. A stepped diameter or collar on the shaft is disposed between first and second bearings to fix an axial position of the flap within the passage and relative to the valve seat. The collar fixes the axial position of the shaft to reduce axial movement of the flap and sealing ring relative to the valve seat.

### CROSS REFERENCE TO RELATED APPLICATION

This application claims priority to U.S. Provisional Application No. 61/060,913 which was filed on Jun. 12, 2008.

### BACKGROUND

Exhaust gas recirculation (EGR) valves include a flap secured to a shaft that is rotated by an electric motor. The flap may be attached to the shaft by way of a weld and include a sealing ring. The sealing ring seals against a valve seat to provide the desired sealing interface between the flap and an interior surface of the valve. Incremental rotation of the shaft provides the desired opening for gas flow through the valve. The interface between the flap and the valve seat provides for positioning within the valve.

Vibration and pressure forces within the system are applied directly to the flap, and thereby the seal and the valve seat. Such forces can prematurely wear the sealing components and cause leakage above desired levels.

### SUMMARY

An exemplary EGR valve includes a shaft supported within a housing. A flap is attached to the shaft and is rotatable to control exhaust gas flow through passage. A stepped diameter or collar on the shaft is disposed between first and second bearings to fix an axial position of the flap within the passage and relative to a valve seat. Because the collar fixes the axial position of the shaft, axial movement of the flap and a sealing ring relative to the valve seat is eliminated or significantly reduced.

Additionally, pressurized exhaust gases fill the space between the bearings and the collar and reduce the contact forces and stresses exerted between the collar and the bearings. Because the contact stresses between the bearings are substantially reduced by the pressure of exhaust gases, the usable and functional life can be increased.

The use of the collar of the shaft to fix axial alignment of the flap relative to the valve seat provides better durability of the sealing ring. Additionally, because the valve seat, sealing ring, and flap are not relied on to provide positional alignment, the materials that comprise each of these structures can be fabricated from less costly materials and processes. Moreover, utilizing pressure to reduce the surface pressures on relative rotating parts, such as the collar and the bearings, further reduces cost and increases durability.

The various features and advantages of this invention will become apparent to those skilled in the art from the following detailed description. The drawings that accompany the detailed description can be briefly described as follows.

### BRIEF DESCRIPTION OF THE DRAWINGS

FIG. 1 is a cross-sectional view of an example EGR valve including a collar for fixing an axial position of a shaft.

FIG. 2 is an enlarged cross-sectional view of the example collar and shaft.

FIG. 3 is an enlarged cross-sectional view of the example collar and bearings.

FIG. 4 is an enlarged cross-sectional view of another example collar and shaft.

### DETAILED DESCRIPTION

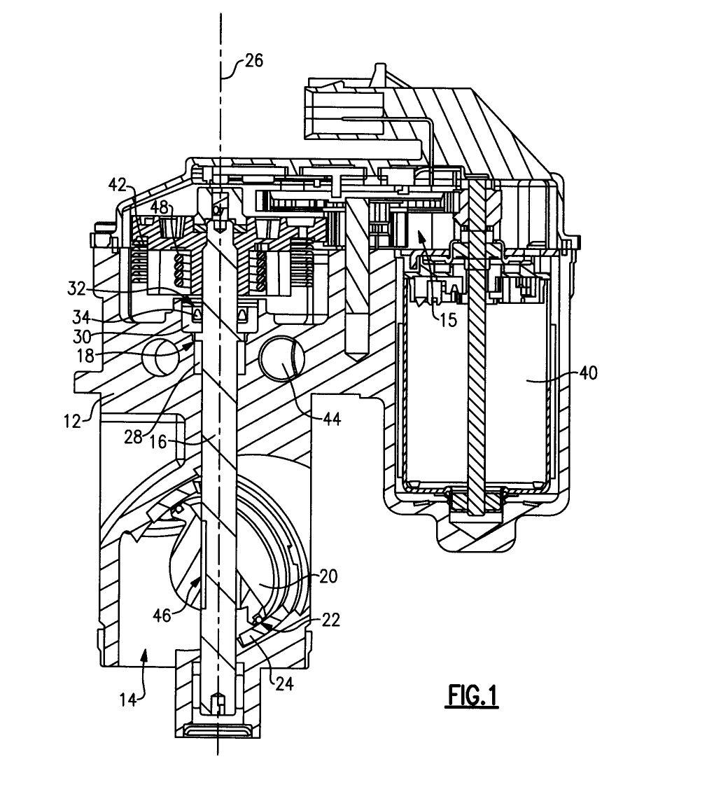

Referring to FIG. 1, an example exhaust gas recirculation (EGR) valve 10 includes a shaft 16 supported within a housing 12. A flap 20 is attached to the shaft 16 and is rotatable to control exhaust gas flow through passage 14. The flap 20 includes sealing ring 22 for sealing against valve seat 24. A stepped diameter or collar 18 on the shaft 16 fixes an axial position of the flap 20 within the passage 14 and relative to the valve seat 24. Because the collar 18 fixes the axial position of the shaft 16, cyclical movement of the flap 20 and sealing ring 22 relative to the valve seat 24 is eliminated or significantly reduced.

The shaft 16 is rotated about axis 26 by a motor 40 through a gear drive 15 to provide the desired incremental opening of the flap 20 for controlling flow of hot gases through the passage 14. The flap 20 is biased toward a closed position by a first spring 42. The first spring 42 returns the flap to the closed position in the absence of power from the motor 40. A second spring 48 will also return the flap 20 to a closed position in instances where the flap 20 is turned in an opposite position for cleaning of a sealing surface on the valve seat 24. As appreciated, the valve seat 24 is desired to be free from contaminants that could detract from the desired sealing contact with the sealing ring 22. Therefore in some instances the motor 40 may drive the flap 20 past a closed position to wipe clean that portion of the valve seat 24 required for providing a desired seal.

The example flap 20 comprises a flat disk portion attached to the shaft 16 at an angle relative to the axis of rotation 26. The angle in which the flap 20 is attached to the shaft 16 corresponds with the configuration of the passage 14. Additionally, the angle of the flap 20 is determined to provide the desired incremental exhaust gas flow relative to rotation of the shaft 16. Attachment of the flap 20 to the shaft 16 is accomplished by way of weld 46. As appreciated other attachment methods are within the contemplation of this invention.

Vibration and pulsating exhaust flow exert cyclical axial forces on the flap 20 that are translated to the shaft 16. Axial movement can reduce the effectiveness of the sealing interface between the sealing ring 22 and the valve seat 24. Accordingly, the example shaft 16 is held in a desired axial position by the collar 18 disposed between a first bearing 28 and a second bearing 30. The first and second bearings 28, 30 are made of self lubricating, long wearing materials that prevent axial shift of the shaft 16 during the operational life of the EGR valve 10.

The second bearing 30 includes an annular cavity 32 within which is disposed a seal 34. The example seal 34 is substantially U-shaped to exert a sealing force against an interior surface of the second bearing 30 and against the shaft 16. The sealing contact between the second bearing 30 prevents exhaust gases from tracking upward into the gear train 15 and motor 40. As appreciated, the excessive temperatures of the exhaust gases are such that it is desirable to prevent leakage of such gases into the valve gear drive train 15 and motor 40.

Further, the housing 12 also defines a cooling passage 14 through which a cooling medium, such as coolant circulating within a vehicle cooling system, flows. The cooling medium maintains the valve drive train 15 and motor 40 at a desirable temperature. The cooling medium from the coolant passage 44 essentially forms a thermal barrier between temperatures generated by hot exhaust gases flowing through the passage 14 and the drive train 15 and motor of the valve 10.

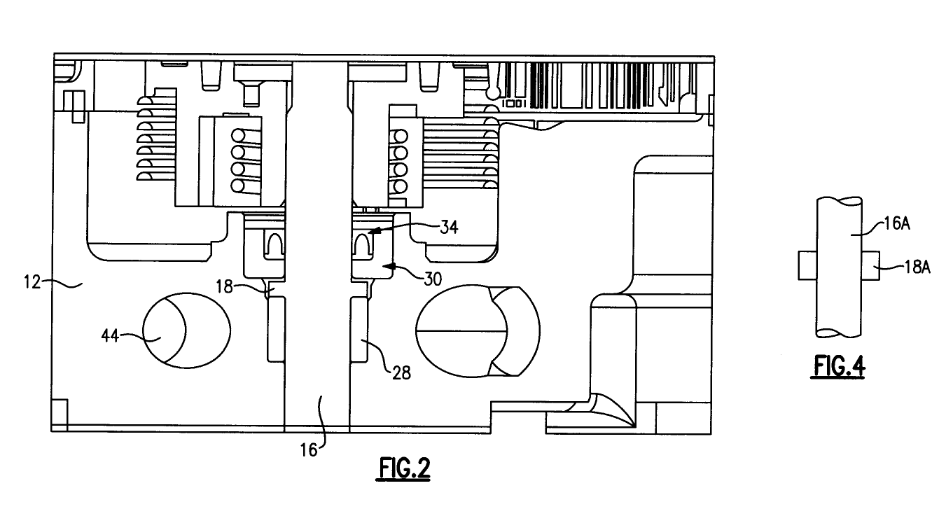

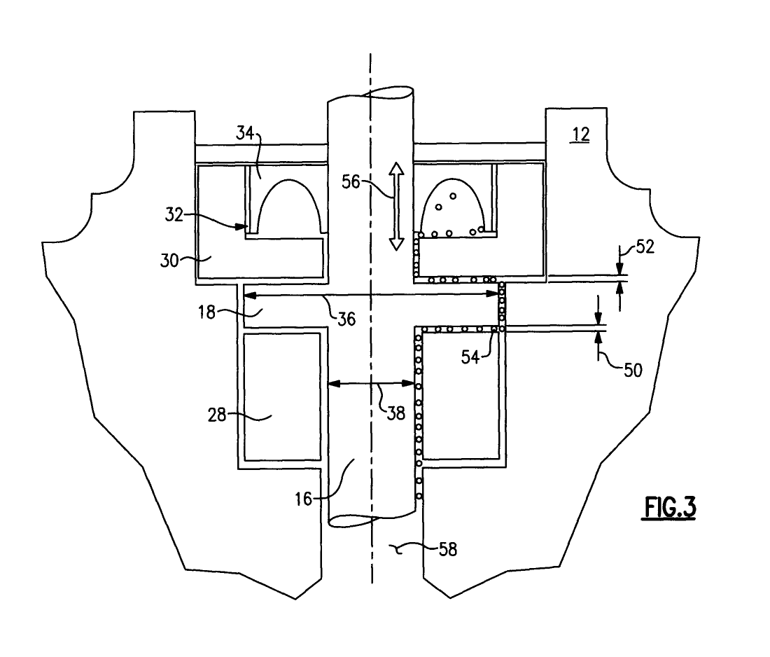

Referring to FIGS. 2 and 3, the collar 18 of the shaft 16 is a stepped diameter portion integral with the shaft 16. The collar 18 comprises a diameter 36 that is larger than the diameter 38 of the shaft 16. The extended diameter 36 of the collar 18 provides for abutment against the bearings 28, 30. The collar 18 is disposed within a space created within a bore 58 of the housing 12 between the first and second bearings 28, 30. The example bearings 28, 30 are press fit within the housing 12 to prevent movement and maintain a desired position.

Referring to FIG. 4, as appreciated, the example collar 18 is an integral part of the shaft 16. However, as shown in FIG. 4, an example shaft 16a may include a separate collar 18a that interfaces with the shaft to prevent relative movement of the flap relative to the valve seat. The collar 18a provides such a fit as to prevent relative movement between the shaft 16a and the collar 18a.

Referring back to FIGS. 2 and 3, a first gap 52 is defined between a top portion of the collar 18 and the second bearing 30. A second gap 50 is disposed between a bottom portion of the collar 18 and the first bearing 28. The gaps 50,52 are in communication with exhaust gases 54 flowing through the passage 14. The communication is through a leak path between the bore 58 and the shaft 16. Accordingly, a minimal amount of exhaust gases leak into this region. An increased pressure results from the presence of exhaust gases in the space between the collar 18 and the bearings 28, 30.

Although axial movement of the shaft is minimized by the first and second bearings 28, 30, some axial movement or biasing is encountered due to cyclical gas flow that exert forces indicated by arrows 56 including an axial component. As the shaft 16 moves axially, pressurized exhaust gases 54 fill the space between the bearings 28, 30 and the collar 18. The pressurized gases reduce the contact forces and stresses exerted between the collar 18 and the bearings 28, 30. Because the contact stresses between the bearings 28, 30 are substantially reduced by the pressure of exhaust gases 54, the usable and functional life can be increased.

The use of the collar 18 of the shaft 16 to fix axial movement of the flap 20 relative to the valve seat 24 provides better durability of the sealing ring 22 and valve seat 24. Additionally, because the valve seat 24, sealing ring 22, and flap 20 are not relied on to provide positional alignment, the materials that comprise each of these structures can be fabricated from less costly materials and processes. Moreover, utilizing pressure to reduce the surface pressures on relative rotating parts, such as the collar 18 and the bearings 28, 30, further reduces cost and increases durability.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. An Exhaust Gas Recirculation (EGR) valve assembly comprising:
a rotatable shaft supported within a housing; and
a flap attached to the shaft and rotatable within the housing for controlling flow through a passage defined within the housing, wherein the shaft includes a collar disposed outside of the passage that fixes an axial position of the flap within the passage.

2. The assembly as recited in claim 1, wherein the passage comprises a valve seat, and the flap includes a sealing ring in sealing contact with the valve seat.

3. The assembly as recited in claim 1, including a first bearing disposed on a first side of the collar and a second bearing disposed on a second side of the collar, the first and second bearings accepting axial thrust loads exerted on the shaft.

4. The assembly as recited in claim 3, wherein the second bearing includes a seal disposed between an inner surface of the second bearing and the shaft.

5. The assembly as recited in claim 4, including a cooling passage for communicating a cooling medium against the first and second bearings.

6. The assembly as recited in claim 4, including first and second gaps above and below the collar filled with pressurized gases that resist axial movement of the shaft such that forces on the first and second bearings are reduced.

7. The assembly as recited in claim 1, wherein the collar comprises a diameter larger than a diameter of the shaft.

8. The assembly as recited in claim 1, including a motor for rotating the flap.

9. An Exhaust Gas Recirculation (EGR) valve assembly comprising:
a rotatable shaft supported within a housing and extending through a passage;
a valve seat defined within the passage;
a flap attached to the shaft for rotation within the passage for controlling flow through the passage;
a sealing ring disposed on the flap and sealing against the valve seat during movement of the flap within the passage; and
a collar disposed on the shaft for fixing an axial alignment of the flap relative to the valve seat.

10. The assembly as recited in claim 9, wherein the flap comprises a disk portion attached to the shaft at an angle relative to an axis of rotation.

11. The assembly as recited in claim 10, wherein the valve seat comprises an insert supported within the housing.

12. The assembly as recited in claim 9, wherein the collar comprises a stepped diameter having a diameter greater than the shaft over a desired axial distance.

13. The assembly as recited in claim 9, including a first bearing supported within the housing on a first side of the collar and a second bearing supported within the housing on a second side of the collar.

14. The assembly as recited in claim 13, wherein one of the first and second bearings comprises an annular cavity containing a seal that seals against the shaft and an inner surface of the one of the first and second bearings.

15. The assembly as recited in claim 13, including at least one gap disposed between the first bearing and the second bearing communicating to generate a pressurized region between the collar and at least one of the first and second bearings.
